(19) United States
(12) Patent Application Publication
(10) Pub. No.: US 2018/0184802 A1
(43) Pub. Date: Jul. 5, 2018

(54) QUICK ASSEMBLY FURNITURE

(71) Applicant: AGIO INTERNATIONAL CO., LTD., TSIMSHATSUI EAST KOWLOON (HK)

(72) Inventors: ChuangXin LIN, Guangdong Province (CN); Martin de Blois, Gallatin, TN (US)

(21) Appl. No.: 15/399,367

(22) Filed: Jan. 5, 2017

(51) Int. Cl. A47B 47/00; A47B 63/00; A47B 96/02; A47B 33/00; A47B 61/00; A47B 31/04; A47B 43/00; F16B 12/10; B65D 21/08

(52) U.S. Cl. CPC A47B 47/0075; A47B 63/00; A47B 96/02; A47B 33/00; F16B 2012/103; A47B 31/04; A47B 43/00; F16B 12/10; B65D 21/08; A47B 61/003

(57) ABSTRACT

A kit is provided that, when assembled, forms a unit of furniture. The kit includes side panels that can rotate about the z axis along the hinge and which have one or more support surfaces to support a base panel. A top panel is connected to the side panels and back panel by a plurality of position members. The kit comprises a plurality of flexible fasteners to reverse-ably lock the side panels to the base panel and to lock the side panels to the top panel and restrict the side panels from z-axis rotation and restrict the base panel and top panel from y-axis rotation. Also provided are methods of assembling and manufacturing the unit of furniture.

### CROSS REFERENCE TO RELATED APPLICATIONS

None.

### STATEMENT REGARDING GOVERNMENT SUPPORT

None.

### FIELD

The present disclosure relates to quick assembly furniture, and more particularly to shelving or storage units wherein the side panels are connected to the back panel by folding hinges that can be locked into open positions via flexible fasteners. This configuration eliminates the need for any tools or know-how for assembly, and greatly enhances the packing efficiency and ease of assembly and disassembly of the unit.

### BACKGROUND

Quick assembly furniture has become quite popular. Manufacturers of such furniture are called upon to offer inexpensive and easy-to-assemble furniture to consumers. Some furniture demanded by consumers, such as shelving or storage units, can be quite bulky and require a large amount of space in order to be shipped pre-assembled. In an effort to provide cost savings to consumers, manufacturers of quick assembly furniture seek ways to ship the furniture as inexpensively as possible.

In order to keep shipping costs down, furniture is typically shipped in multiple components that must be assembled by the consumer upon arrival. A shipment of multiple components of furniture may create problems. At times, components may inadvertently be left out of the shipping box when it is shipped. The packaging of the furniture may be damaged during shipping, resulting in tears to the shipping box and the loss of smaller components or the directions. Because the consumer must attach the hardware to the furniture components, the consumer is generally required to use tools and must, at times, follow complicated assembly instructions. Assembly performed by the consumer may not be as stable as factory assembly, due to the superior capabilities of factory assembly tools relative to the capabilities of tools normally available to or used by consumers. Additionally, once the furniture is assembled, it may be impossible or exceptionally difficult to disassemble the furniture without damaging the components.

FIG. 1A illustrates a conventional kit for a unit of furniture having a back panel 101 and side panel 102 that are assembled by an L-shaped bracket 111, nut 112, and screw 113. FIG. 1B illustrates another configuration of a back panel 101 and side panel 102 that are assembled by an L-shaped bracket 111, and two screws 113. FIG. 1C illustrates a third teaching in which a back panel 101 and side panel 102 are assembled by a flat bracket 114 and two screws 113.

In all of the configurations of FIGS. 1A-C, the consumer must possess the necessary tools to attach the back panels 101 and side panels 102. The necessary tools may include a hammer, a drill, a screw driver (which may be one of any size of a phillips head, flat head, square head, star head (available from Textron Indus., Inc. under the Torx® name), or other shape, and a wrench (which may be one of any size of an open-end, box-end, combination, flare-nut, ratcheting box, socket, etc.). Further, a consumer may need a requisite amount of physical strength to drive the screws into some panels. Once the kit is assembled, the unit of furniture is in its permanent final configuration, and it is only with great difficulty and potential damage to the unit that the unit can be disassembled.

The consumer must also possess the necessary know-how to assemble the kit. This means being able to read and follow any instruction manual(s) sent with the kit. At times, the instruction manual(s) may be complicated and/or confusing. At times, the instruction manual(s) may not be included with the kit or may be lost during shipment. At times, the language(s) of the instruction manual(s) may not be the language of the consumer. These situations lead to the consumer adopting a trial-and-error method to determine the correct configuration of the components. The consumer may waste time and energy building the wrong configuration, or may end with a sub-optimal unit due to less-than-optimal placement of all the components.

Conventional approaches for a manufacturer that does not desire to have the consumer assemble the unit using his or her own tools and/or follow an instruction manual, is that the unit must be assembled by the manufacturer prior to shipment. This assembly results in increased space required for shipping, and therefore increases costs.

A further aspect of prior art approaches is that consumers may damage portions of the kit, either during assembly and disassembly, or simply during the everyday use of the article of furniture. Such articles are often fabricated using materials such as particle board or medium density fiberboard (MDF), for example. Conventionally, the fully assembled product is a rigid item of furniture, suited for its designed purpose. However, these materials of construction may be vulnerable to failure when stresses are applied to connection points or joints. A joint is the close securing or fastening together of two or more smooth, even surfaces—customarily rigid. In formal furniture sold in assembled form, joints are typically secured by dowels, dovetails, dados, glue blocks, rabbets, etc. In kit or knock-down furniture, joints are commonly made rigid by custom connecting fasteners, connector bolts, or through-bolts mating with fixed nuts. A disadvantage with this approach is that the improper positioning of fastening elements during assembly may result in weakened connection points or joints. In addition, rigid designs may result in the imposition of full stress of use on even properly positioned connection points or joints, possibly leading to failure of connections. Kit or knock-down furniture is likely to be relocated or disassembled for transport, and the joints are weak points. It would be desirable to provide a kit of furniture adapted to such stress, while still amenable to easy assembly and disassembly.

In all of the configurations of FIGS. 1A-C, the consumer must possess the necessary tools and know-how to attach the back panels and side panels. Improper positioning of fastening elements during assembly may result in weakened connection points or joints. In addition, rigid designs may result in the imposition of full stress of use on even properly positioned connection points or joints, possibly leading to failure of connections.

There remains a need to simplify the process of assembling furniture while retaining the ability to ship the furniture in as small a container as possible. There also remains a need to create furniture that can be easily disassembled for transport to other locations.

### BRIEF SUMMARY

The present disclosure relates to a kit that, when assembled, forms a unit of furniture. The kit comprises: a back panel having a height along a y-axis, a width along an x-axis, and a thickness along a z-axis; a plurality of position members; wherein the side panel defines at least one upwardly facing support surface extending along an x-z plane; wherein the back panel is configured to extend along an x-y plane, the back panel having a top, a bottom, and two sides; wherein each of the side panels has a top, a bottom, and two sides and is attached to an opposing side of the back panel by a folding hinge at a side of the side panel, wherein the side panels are configured to rotate about the y axis along the hinge from a closed position substantially parallel to the back panel to an open position that extends along a y-z plane; wherein each of the side panels is configured to define at least one position member receptacle on the top of the side panel, with the plurality of position members configured to extend along the y-axis when installed into the top of the side panels; wherein the base panel, upon assembly, is configured to extend along an x-z plane, and the base panel may be positioned on top of the support surface and between the side panels; wherein the top panel, upon assembly, is configured to extend along an x-z plane, positioned on top of the side panels, wherein the top panel upon assembly may be connected to the side panels by the plurality of position members installed into the top of the side panels and a bottom surface of the top panel, and wherein the position members restrict the top panel from relative movement along the x and z axes; and a plurality of pre-installed flexible fasteners, wherein a toggle portion of the fasteners is mounted to the side panel and at least one hook portion of a fastener is mounted to a bottom portion of the base panel, and at least one hook portion is mounted to a bottom portion of the top panel, and wherein the toggle portions reversibly attach to the plurality of hook portions to lock the side panels to the base panel and to lock the side panels to the top panel and to restrict the side panels from relative rotation about the y-axis and restrict the base panel and top panel from y-axis movement relative to the side panels.

In one embodiment, the fastener comprises a spring loaded toggle latch such that the unit is resilient upon loading and unloading.

In one embodiment, the position member is selected from the group consisting of a pin, a biscuit, a dowel, and a spline.

In one embodiment, the back panel comprises at least one position member receptacle at the top, and the kit is further configured such that at least one position member may be installed into the back panel.

In one embodiment, the position members may be removably installed.

In one embodiment, the support surface is defined by a support plate affixed to a lower portion of the side panel.

In one embodiment, the support plate is removably affixed to the side panel.

In one embodiment, the width of the side panels is equal to or less than one half of the width of the back panel.

In one embodiment, upon assembly the side panels swing away from the back panel by rotation along the y-axis, and the side panels may be substantially parallel to each other and extend along the y-z plane when the fasteners are locked.

In one embodiment, the kit comprises one or more shelves extending along an x-z plane and, upon assembly, the one or more shelves is removably attached to an inside portion of the side panels.

In one embodiment, the kit comprises one or more door panels that, upon assembly, extend along an x-y plane when closed so as to seal all or a portion of the case storage volume, and the one or more door panels may be pivotally attached to a front portion of the side panels when assembled.

In one embodiment, the unit is selected from the group consisting of a book shelf, a storage shelf, a cabinet, a bar table, an armoire, a case, a chiffonier, a closet, a dresser, a locker, a wardrobe, a case, a bin, a vault, a buffet, and a sideboard.

In one embodiment, the panels are manufactured from a material selected from the group consisting of MDF, plywood, hardboard, wood, metal, and plastic.

In another embodiment, the present disclosure relates to a method of manufacturing a kit that is designed, when assembled, to form a unit of furniture, the method comprising: providing a back panel, a top panel, a base panel, and two side panels that, when assembled, form a case, the case defining a storage volume having a height along an y-axis, a width along an x-axis, and a thickness along a z-axis, wherein the back panel is configured to extend along an x-y plane, the back panel having a top, a bottom, and two sides, and wherein each of the two side panels have a top, a bottom, and two sides; attaching the side panels to opposite ends of the back panel along a y-axis by a plurality of folding hinges along the sides of the side panels, wherein the side panels may be in a closed position substantially parallel to the back panel, and wherein the side panels may be rotated on the y axis and configured so as to unfold to an open position such that the side panels may extend along a y-z plane, substantially parallel to each other, and at right angles to the back panel, the tops of the side panels and back panel forming a contiguous top surface in an x-z plane; providing at least one support surface, wherein the side panels are configured to define at least one upwardly facing support surface extending along an x-z plane, wherein the support surface is defined by a support plate affixed to a lower portion of the side panel, providing a plurality of position members, wherein the top surface of the side panels and back panel are configured to define position member receptacles, the position members configured along the y-axis when installed into the position member receptacles; providing a plurality of hook and toggle fasteners; wherein the base panel is configured on assembly to be placed on top of the plurality of support plates so as to extend along the x-z plane; providing a top panel configured on assembly to be placed over a top portion of the side panels and back panel, wherein the top panel defines position member receptacles and is configured to be connected to the side panels by the plurality of position members when installed into the top of the side panels; wherein the side panels are configured to define toggle receptacles at a point proximate to a lower portion of the base panel when installed and at a point proximate to a lower portion of the top panel when installed, and wherein the base panel is configured to define at least one hook receptacle on a lower portion of the base panel, and the top panel is configured to define at least one hook receptacle on a lower portion of the top panel; and wherein when hook and toggle fasteners are configured such that when the base panel is placed over the tops of the side support plates and the top panel is placed over the tops of the side panels and back panel, the hook and toggle fasteners are capable of alignment so as to lock the base panel to the side panels and to lock the top panel to the side panels.

In one embodiment, the method comprises providing one or more shelves, and the kit is configured so that the one or more shelves may be attached to an inside portion of the two side panels.

In one embodiment, the method comprises providing one or more door panels that, upon assembly, are configured to be pivotally attached to the front portion of the side panels.

In one embodiment, the fastener comprises a spring loaded toggle latch such that an assembled unit is resilient upon loading and unloading.

In one embodiment, the back panel defines at least one position member receptacle within the contiguous top surface.

### DESCRIPTION OF THE DRAWINGS

FIG. 1A is a front perspective view of the prior art teaching of a front and side panel that are assembled by an L-shaped bracket, nut, and screw. FIG. 1B is a front perspective view of the prior art teaching of a front and side panel that are assembled by an L-shaped bracket and two screws. FIG. 1C is a front perspective view of the prior art teaching of a front and side panel that are assembled by a flat bracket and two screws.

FIG. 2A is a front left perspective view of an assembled kit with the reference axes shown and labeled. FIG. 2B is a front left perspective cut away view of the disassembled kit in an open configuration. FIG. 2C is a front left perspective cut away view of the disassembled unit in a closed configuration.

FIG. 3A is a front left perspective partial assembly view of a support plate attached to a lower portion of the side panel that supports a base panel. FIG. 3B is a front left perspective partial assembly view of the configuration of the unit upon placement of the base panel.

FIG. 4 is a bottom plan view of the base panel that shows the position of the fasteners that reversibly join the side panels to the base panel.

FIG. 5 is a front left perspective view of the unit that illustrates the position of the top panel prior to its placement onto the top surface of the side panels and back panel.

FIG. 6 is a front left perspective view looking upward from the base that shows the position of the fasteners that reversibly join the side panels to the top panel.

FIG. 7A is a front right perspective view of one embodiment of fastener. FIG. 7B is a front right perspective view of another embodiment of fastener.

FIG. 8 is a front left perspective view of one embodiment in which shelves divide the space of the enclosure formed by the top panel, base panel, and side panels.

FIG. 9 is a front left perspective view of one embodiment in which one door panel, when closed, seals all or a portion of the case storage volume formed by the top panel, base panel, and side panels.

FIG. 10 is a front left perspective view of the kit in which all components are disassembled.

FIG. 11 shows a flow chart outlining the steps of the method of assembly.

FIG. 12 shows a flow chart outlining the steps of the method of manufacture.

### DESCRIPTION

The following description includes various embodiments and method of carrying out exemplary embodiments of the present approach. The description is not to be taken in a limiting sense, and is made merely for the purpose of illustrating the general principles of the present approach.

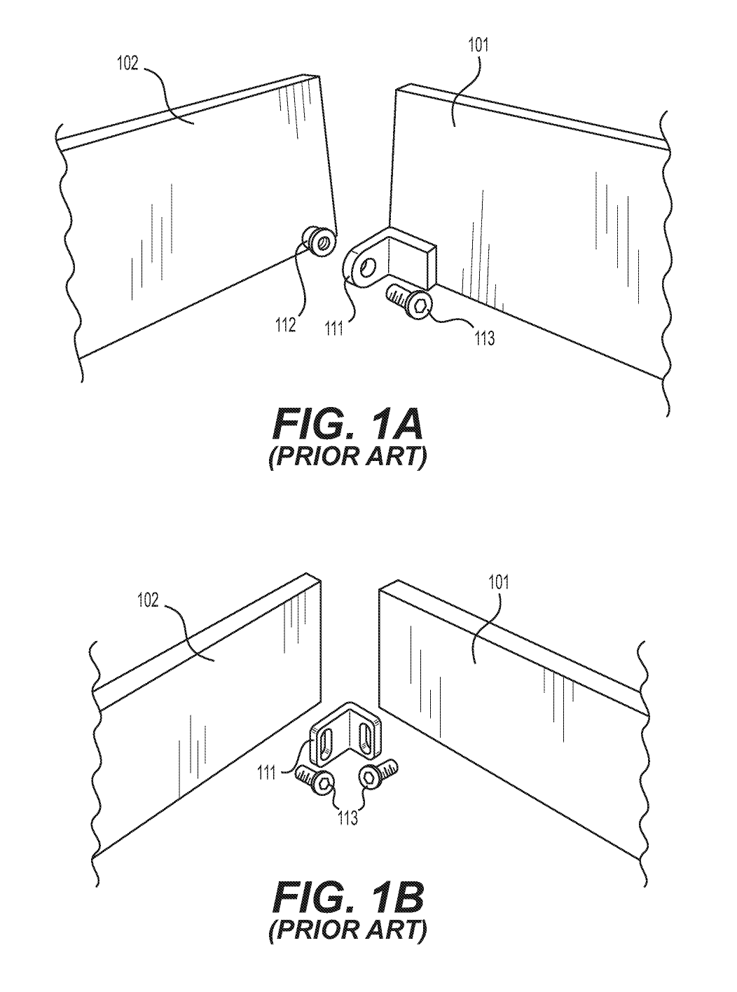

The present invention overcomes the limitations of the conventional furniture kits that are illustrated in FIG. 1A-C.

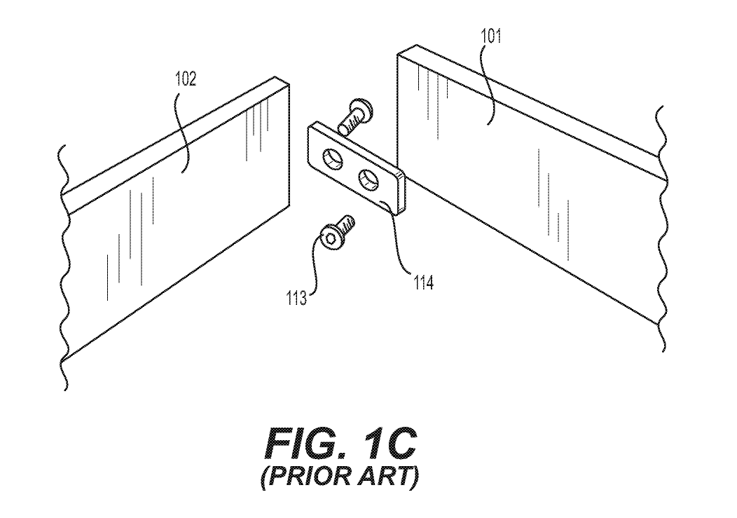

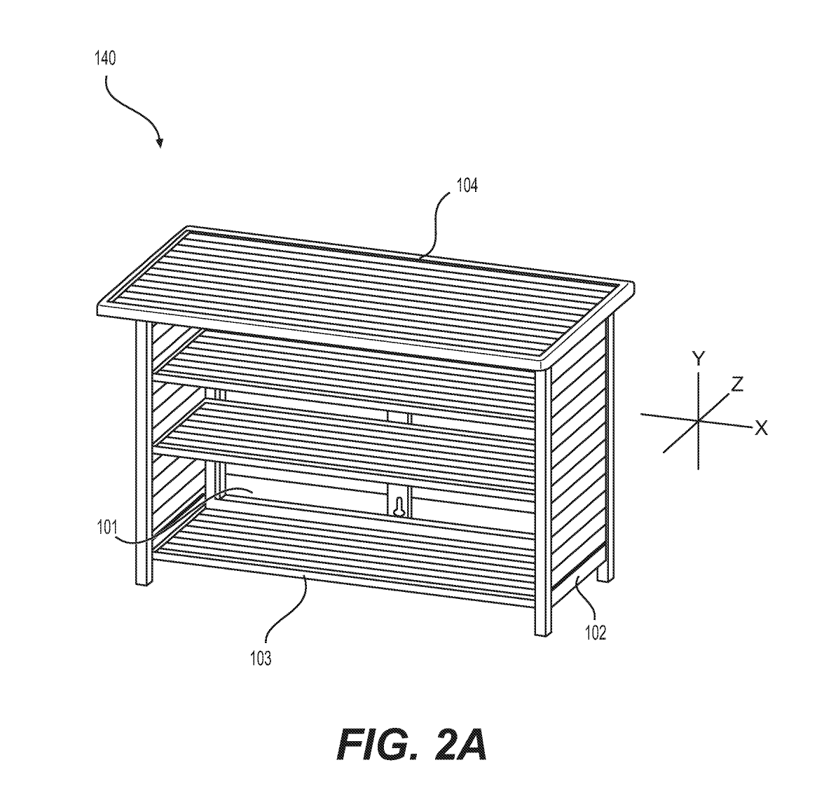

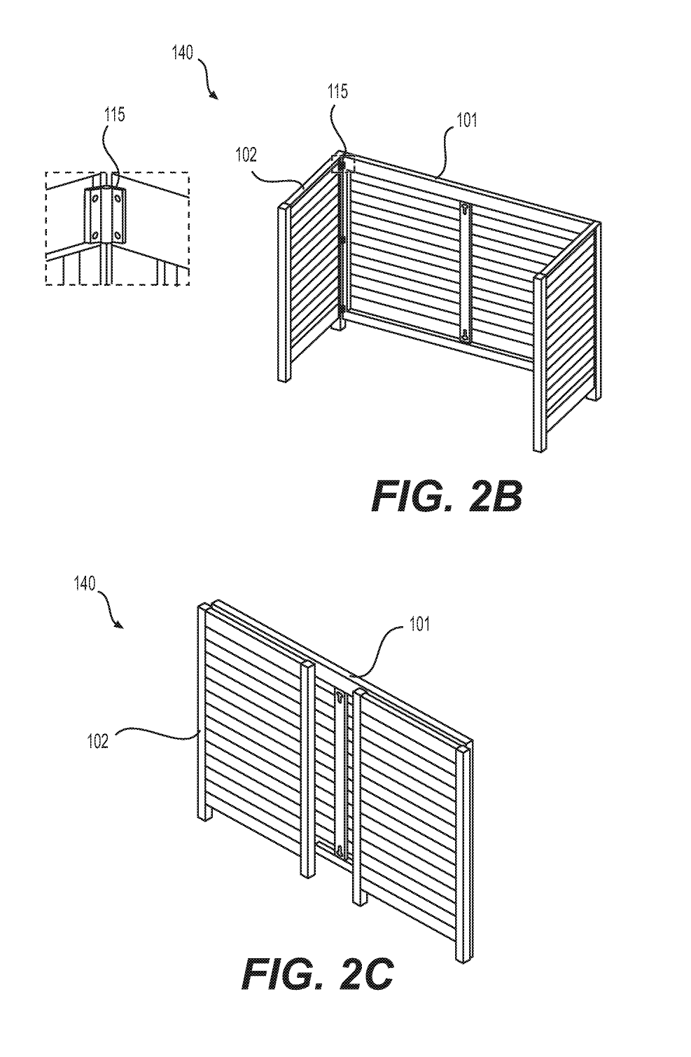

FIG. 2 demonstrates certain advantages of the present approach. FIG. 2A illustrates an embodiment of an assembled kit 140 with the reference axes shown and labeled. FIG. 2B illustrates a cut away view of the kit 140 in an open configuration. In one embodiment, the back panel 101 and side panels 102 are joined by one or more folding hinges 115. In the open configuration of this embodiment, the side panels 102 are at right angles to the back panel 101 and are substantially parallel to each other. FIG. 2C illustrates a cut away view of the kit 140 in a closed configuration. In this embodiment, the side panels 102 are folded in and are substantially parallel to the back panel 101. FIG. 2C is typical of the embodiment that would be shipped to the consumer, and FIG. 2B is typical of the embodiment that the consumer would make by unfolding the side panels 102 away from the back panel 101. A consumer needs to merely swing open the side panels 102 such that they are at right angles to the back panel 101 and are substantially parallel to each other. No tools are needed, and little, if any, know-how is needed, as the side panels 102 can only swing in one direction, away from the back panel 101.

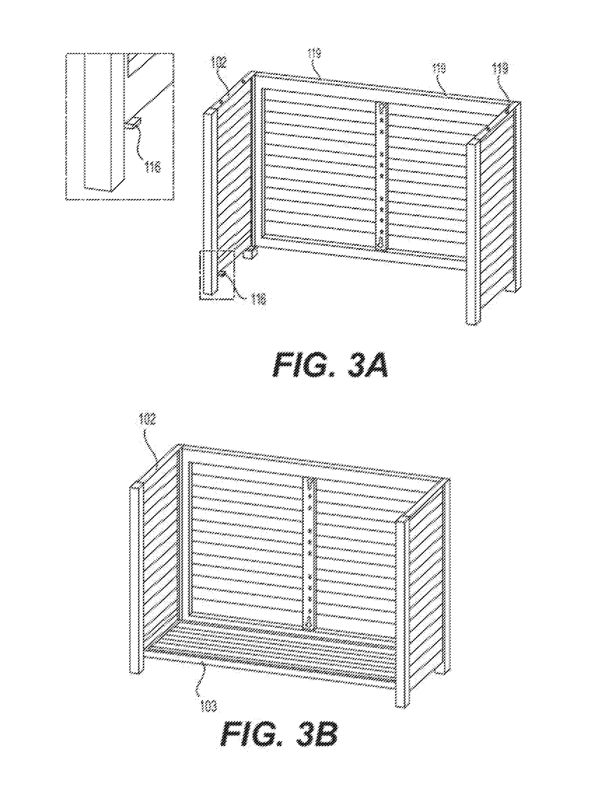

FIGS. 3A and 3B demonstrate the ease of the base panel assembly. FIG. 3A illustrates an upwardly facing support face defined by at least one rigid support plate 116 affixed to a lower portion of the side panel 102 that supports a base panel 103 at the base of the two side panels 102. The base portions of the side panels 102 face the back panel 101 when in a closed position and the at least one rigid support plate 116 extends along an x-z plane when the side panels 102 are in the open position. The at least one rigid support plate 116 may be attached in any manner of ways known in the art. In one embodiment, the at least one rigid support plate 116 may be welded to the lower portion of the side panel 102 by the manufacturer. In one embodiment, the at least one rigid support plate 116 is removably affixed to the side panel 102. FIG. 3B illustrates the configuration of the unit upon placement of the base panel 103 onto the one or more rigid support plates 116. A consumer needs to merely place the base panel 103 onto the support plates 116 that are attached to the side panels 102. No tools and little, if any, know-how is needed.

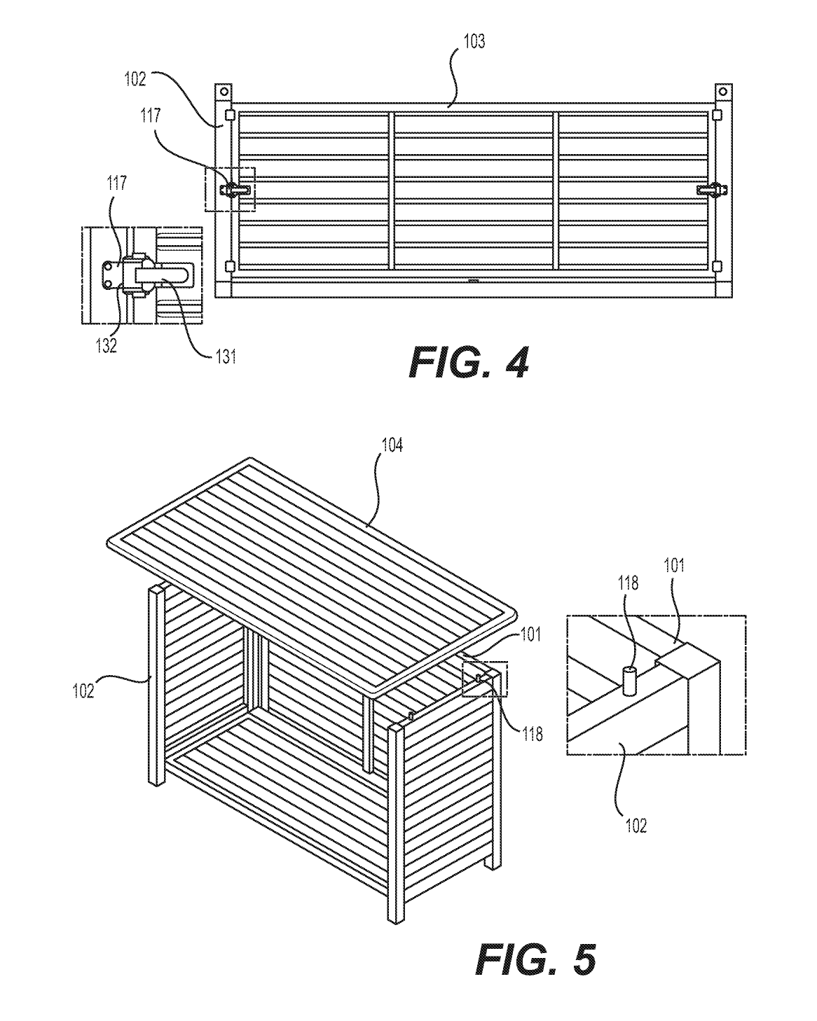

FIG. 4 demonstrates an approach by which the unit of furniture is made stable and yet can be assembled and disassembled in a quick and easy manner. FIG. 4 shows a cut away view of an embodiment of the unit and illustrates a configuration positioning a plurality of pre-installed flexible fasteners 117 that join the side panels 102 with the base panel 103. The flexible fasteners 117 may be installed in any manner of ways known in the art. The fasteners 117 lock the side panels 102 with the base panel 103 at right angles. A toggle portion 131 of each fastener 117 may be mounted to the side panel 102 and a hook or toggle receptacle portion 132 of each fastener is mounted to a bottom portion of the base panel 103. The toggle portion 131 reversibly attaches to the toggle receptacle 132 to lock the side panels 102 to the base panel 103 and restrict the side panels 102 from z-axis rotation and restrict the base panel 103 from y-axis rotation. The toggle portion 131 and toggle receptacle 132 may be mounted to the side panels 102 and base panel 103 by the manufacturer. The consumer merely needs to lock the corresponding toggle portion 131 and toggle receptacle 132 of the fastener 109 together to create a resilient, stabilized unit.

FIG. 5 illustrates the position of the top panel 104 onto the top surface of the side panels 102 and back panel 101. The top panel 104 is shown connected to the side panels 102 and back panel 101 by a plurality of position members 118 mounted to a top edge of the side panels 102 and a bottom surface of the top panel 104, with the position members 118 oriented along the y-axis. The position members 118 are shown in the figures as pins, but other embodiments of position members, such as biscuits, dowels, and splines may be acceptable alternatives, depending on the application and type of furniture. The position members 118 fit into corresponding position member receptacles 119 on the opposite surface. The position members 118 restrict the top panel 108 from x and z axis movement. For this embodiment, a consumer need merely place the top panel 104 onto the top surface of the side panels 102 and back panel 101, aligning the position members 118 with the position member receptacles 119, to assemble the top panel 104.

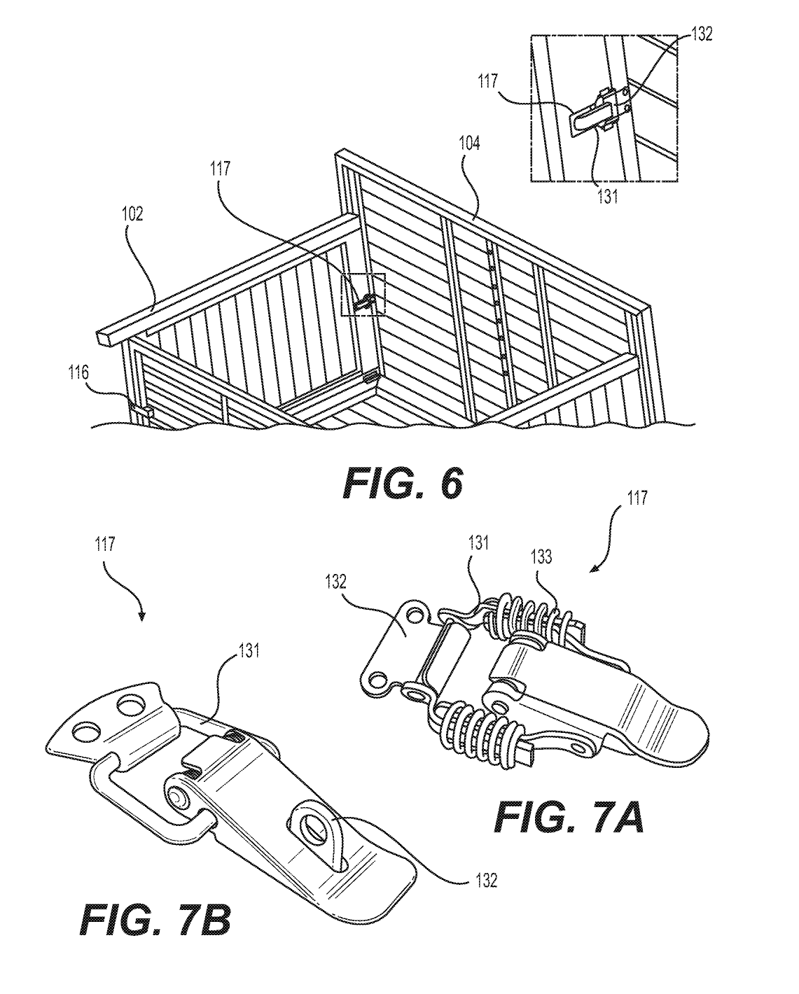

FIG. 6 illustrates the fasteners 117 that may be used to join the side panels 102 to the top panel 104. In one embodiment, a toggle portion 131 of each fastener 117 may be mounted to the side panel 102 and a toggle receptacle or hook portion 132 of each fastener may be mounted to a bottom portion of the top panel 104. In another embodiment, a toggle portion 131 of each fastener 117 may be mounted to a bottom portion of the top panel 104 and a toggle receptacle or hook portion 132 may be mounted to the side panel 102. The toggle portion 131 reversibly attaches to the toggle receptacle or hook portion 132 to release-ably lock the side panels 102 to the top panel. Once fastened, the fasteners restrict the side panels 102 from z-axis rotation and restrict the top panel 104 from y-axis rotation. The consumer merely needs to latch the toggle portion 131 to the toggle receptacle portion 132 to complete this portion of the assembly and create a resilient, stabilized unit.

FIG. 7 illustrates various embodiments of the flexible hook and toggle fasteners 117. The fasteners 117 may include a toggle portion 131 that is spring loaded 133, which provides constant tension for secure latching. A spring loaded toggle latch 133 makes the unit resilient upon loading and unloading due to its flexibility in range of motion. “Resilient” may be defined as fastening that permits a minor deformation at the joint, with the ability to return to shape after loading, but not so rigid as to damage the surrounding furniture material to which the fastener is mounted, as might occur with a glued or otherwise rigid joint of MDF, for example. “Deformation” in this context involves both extension and compression along the axis of any spring within fastener 117, but also rotation of the latching ring 142 about its mount on toggle portion 131 or about its connection point on toggle receptacle portion 132. Thus, the degree of resilience desired is a function of the specifications of any springs, as well as the relation of latching ring 142 to its mount or connection point design.

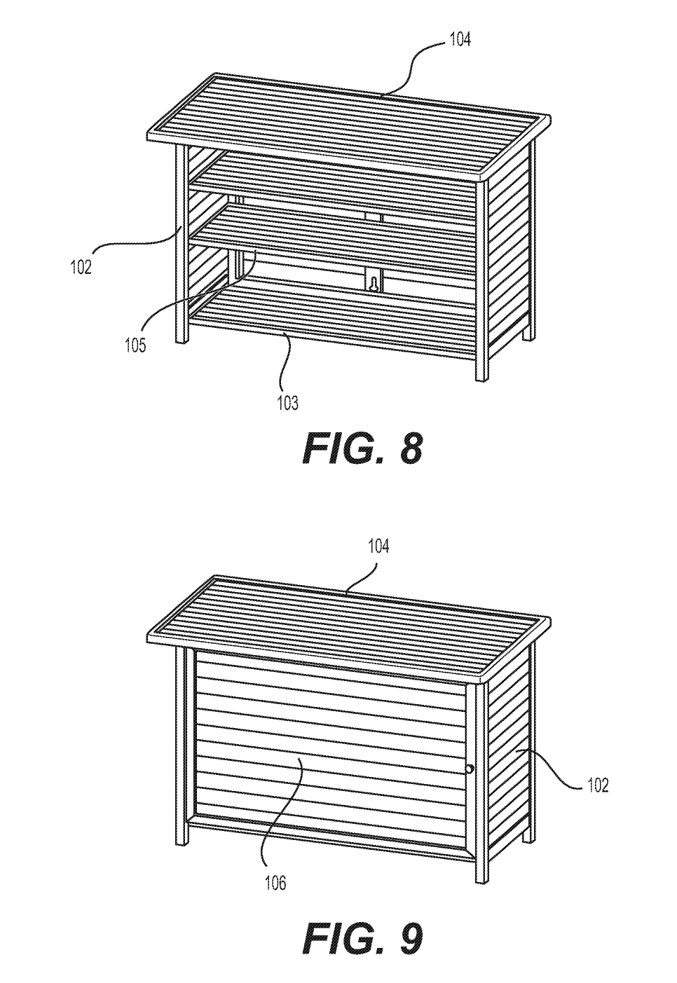

Optionally, one or more shelves 105 may be included to divide the case storage volume formed by the top panel 104, base panel 103, and side panels 102, as is shown in FIG. 8. The one or more shelves 105 are generally attached to the inside portion of the side panels 102 such that the shelves 105 extend along an x-z plane and are positioned between the side panels 102. The one or more shelves 105 can be attached in any manner of ways known in the art.

Optionally, one or more door panels 106 may be included to seal off all or a portion of the case storage volume formed by the top panel 104, the base panel 103, and the side panels 102, as is shown in FIG. 9. The one or more door panels 106 can be attached in any manner of ways known in the art. FIG. 9 shows one embodiment in which one door panel 106 closes off the space of the enclosure.

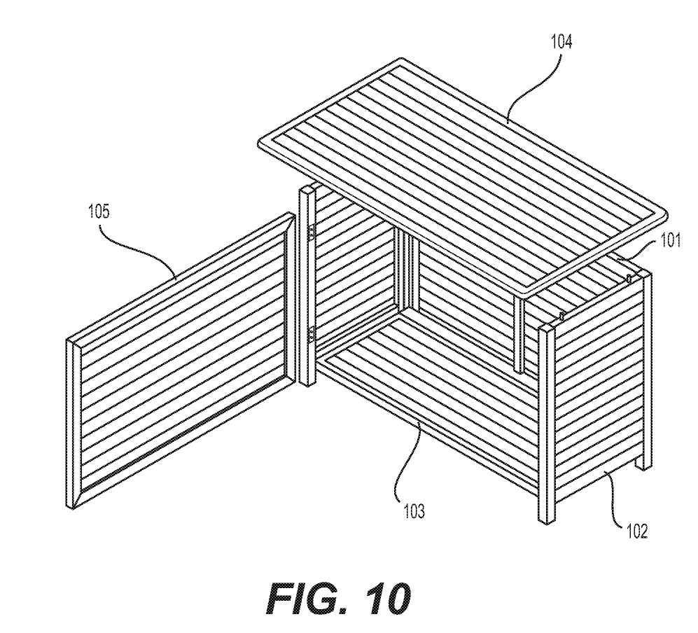

FIG. 10 illustrates a view of the kit with all of the components disassembled. A consumer may receive this arrangement in a shipped kit.

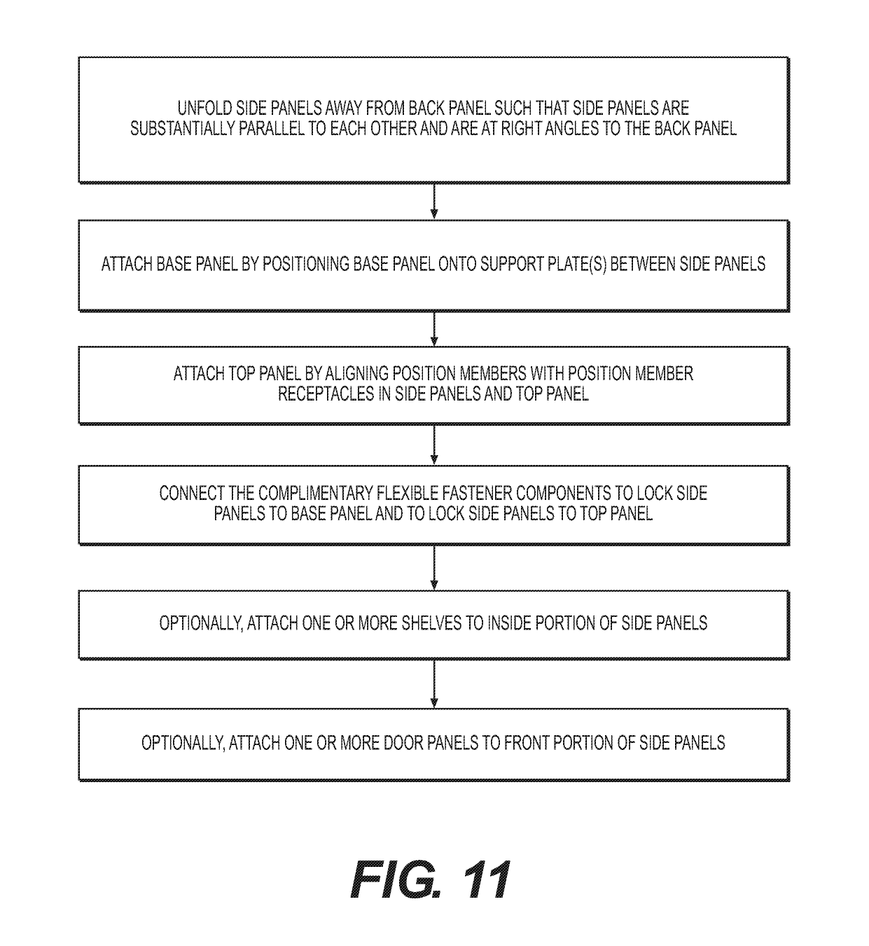

FIG. 11 illustrates a flow chart outline of the steps of the method of assembly. These steps illustrate the information that may be found on a kit assembly instruction page or manual. In the first step, a consumer unfolds the side panels 102 away from the back panel 101 such that the side panels 102 are substantially parallel to each other and are at right angles to the back panel 101. In the next step, the consumer attaches the base panel 103 by positioning the base panel 103 onto the one or more rigid support plates 116 between the side panels 102. In the next step, the consumer attaches the top panel 104 by aligning position members 118 with position member receptacles 119 in the side panels 102 and top panel 104. Next, the consumer connects the complimentary flexible fastener 117 components to lock the side panels 102 to the base panel 103 and to lock the side panels 102 to the top panel 104. Optionally, the consumer may attach one or more shelves 105 to the inside portion of the side panels 102. Optionally, the consumer may attach one or more door panels 106 to a front portion of the side panels 102.

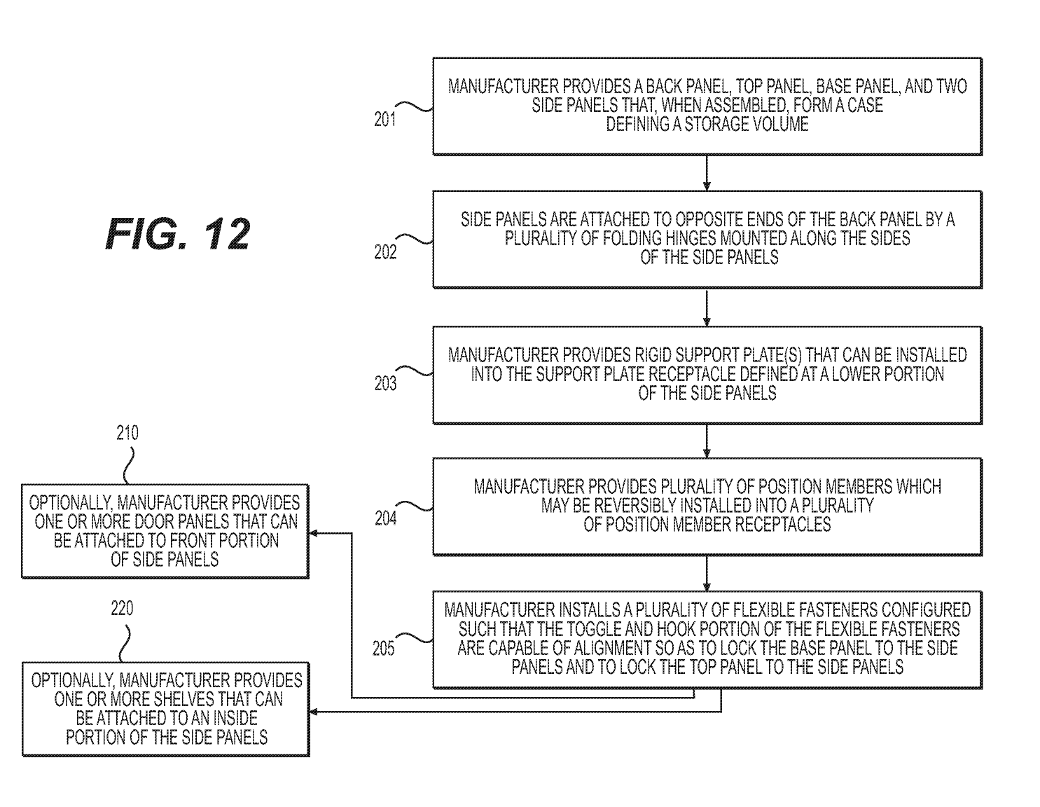

FIG. 12 illustrates a flow chart outline of the steps of a process or method for manufacturing the kit 140 that, when assembled, forms a unit of furniture. In the first step, a manufacturer provides 201 a back panel 101, top panel 104, base panel 103, and two side panels 102 that, when assembled, form a case defining a storage volume. In the next step, the side panels 102 are attached 202 to opposite ends of the back panel 101 by a plurality of folding hinges 115 mounted along the sides of the side panels 102. In the next step, at least one rigid support plate 116 is provided 203 which can be installed into a lower portion of the side panels 102. In the next step, a manufacturer provides 204 a plurality of position members 118 which may be reversibly installed into a plurality of position member receptacles 119 defined by the top surface of the side panels 102 and back panel 101. In the next step, a manufacturer installs 205 a plurality of flexible fasteners 117, wherein the flexible fasteners 117 are configured such that when the base panel 103 is placed over the tops of the one or more rigid support plates 116 and the top panel 104 is placed over the tops of the side panels 102 and back panel 101, the toggle portion 131 and hook portion 132 of the flexible fasteners 117 are capable of alignment so as to lock the base panel 103 to the side panels 102 and to lock the top panel 104 to the side panels 102. Optionally, a manufacturer may provide 210 one or more shelves 105 that may be attached to an inside portion of the two side panels 102. Optionally, in a manufacturer may provide 220 one or more door panels 106 that may be pivotally attached to a front portion of the side panels 102. Further, a manufacturer may provide such alternative embodiments of kit 140 described herein.

The terminology used herein is for the purpose of describing particular embodiments only and is not intended to be limiting of the approach. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The present approach may be embodied in other specific forms without departing from the spirit or essential characteristics thereof. The disclosed embodiments are therefore to be considered in all respects as illustrative and not restrictive, the scope of the present approach being indicated by the claims of the application rather than by the foregoing description, and all changes which come within the meaning and range of equivalency of the claims are therefore intended to be embraced therein. One of ordinary skill in the art should appreciate that numerous possibilities are available, and that the scope of the present approach is not limited by the embodiments described herein.

What is claimed is:

1. A kit that, when assembled, forms a unit of furniture, the kit comprising:
a back panel, a top panel, a base panel, and two side panels that, when assembled, form a case, the case defining a storage volume having a height along a y-axis, a width along an x-axis, and a thickness along a z-axis;
a plurality of position members;
wherein the side panel defines at least one upwardly facing support surface extending along an x-z plane;
wherein the back panel is configured to extend along an x-y plane, the back panel having a top, a bottom, and two sides;
wherein each of the side panels has a top, a bottom, and two sides and is attached to an opposing side of the back panel by a folding hinge at a side of the side panel, wherein the side panels are configured to rotate about the y axis along the hinge from a closed position substantially parallel to the back panel to an open position that extends along a y-z plane;
wherein each of the side panels is configured to define at least one position member receptacle on the top of the side panel, with the plurality of position members configured to extend along the y-axis when installed into the top of the side panels;
wherein the base panel, upon assembly, is configured to extend along an x-z plane, and the base panel may be positioned on top of the support surface and between the side panels;
wherein the top panel, upon assembly, is configured to extend along an x-z plane, positioned on top of the side panels, wherein the top panel upon assembly may be connected to the side panels by the plurality of position members installed into the top of the side panels and a bottom surface of the top panel, and wherein the position members restrict the top panel from relative movement along the x and z axes; and
a plurality of pre-installed flexible fasteners, wherein a toggle portion of the fasteners is mounted to the side panel and at least one hook portion of a fastener is mounted to a bottom portion of the base panel, and at least one hook portion is mounted to a bottom portion of the top panel, and wherein the toggle portions reversibly attach to the plurality of hook portions to lock the side panels to the base panel and to lock the side panels to the top panel and to restrict the side panels from relative rotation about the y-axis and restrict the base panel and top panel from y-axis movement relative to the side panels.

2. The kit of claim 1, wherein the fastener comprises a spring loaded toggle latch such that the unit is resilient upon loading and unloading.

3. The kit of claim 1, wherein the position member is selected from the group consisting of a pin, a biscuit, a dowel, and a spline.

4. The kit of claim 1, wherein the back panel further comprises at least one position member receptacle at the top, and the kit is further configured such that at least one position member may be installed into the back panel.

5. The kit of claim 4, wherein the position members may be removably installed.

6. The kit of claim 1, wherein the support surface is defined by a support plate affixed to a lower portion of the side panel.

7. The kit of claim 6, wherein the support plate is removably affixed to the side panel.

8. The kit of claim 1, wherein the width of the side panels is equal to or less than one half of the width of the back panel.

9. The kit of claim 1 wherein upon assembly the side panels swing away from the back panel by rotation along the y axis, and wherein the side panels may be substantially parallel to each other and extend along the y-z plane when the fasteners are locked.

10. The kit of claim 1, wherein the kit comprises one or more shelves extending along an x-z plane and wherein, upon assembly, the one or more shelves is removably attached to an inside portion of the side panels.

11. The kit of claim 1, further comprising one or more door panels that, upon assembly, extend along an x-y plane when closed so as to seal all or a portion of the case storage volume, and wherein the one or more door panels may be pivotally attached to a front portion of the side panels when assembled.

12. The kit of claim 1, wherein the unit is selected from the group consisting of a book shelf, a storage shelf, a cabinet, a bar table, an armoire, a case, a chiffonier, a closet, a dresser, a locker, a wardrobe, a case, a bin, a vault, a buffet, and a sideboard.

13. The kit of claim 1, wherein the panels are manufactured from a material selected from the group consisting of MDF, plywood, hardboard, wood, metal, and plastic.

14. A method of manufacturing a kit that is designed, when assembled, to form a unit of furniture, the method comprising:
providing a back panel, a top panel, a base panel, and two side panels that, when assembled, form a case, the case defining a storage volume having a height along an y-axis, a width along an x-axis, and a thickness along a z-axis, wherein the back panel is configured to extend along an x-y plane, the back panel having a top, a bottom, and two sides, and wherein each of the two side panels has a top, a bottom, and two sides;
attaching the side panels to opposite ends of the back panel along a y-axis by a plurality of folding hinges along the sides of the side panels, wherein the side panels may be in a closed position substantially parallel to the back panel, and wherein the side panels may be rotated on the y axis and configured so as to unfold to an open position such that the side panels may extend along a y-z plane, substantially parallel to each other, and at right angles to the back panel, the tops of the side panels and back panel forming a contiguous top surface in an x-z plane;
providing at least one rigid support plate, the lower portions of the side panels facing the back panel when in a closed position and the at least one rigid support plate extending along an x-z plane when affixed to the lower portion of the side panel and the side panels are in the open position;
providing a plurality of position members, wherein the top surface of the side panels and back panel are configured to define position member receptacles, the position members configured along the y-axis when installed into the position member receptacles;
providing a plurality of flexible fasteners;
wherein the base panel is configured on assembly to be placed on top of at least one rigid support plate so as to extend along the x-z plane;
providing a top panel configured on assembly to be placed over a top portion of the side panels and back panel, wherein the top panel defines position member receptacles and is configured to be connected to the side panels by the plurality of position members when installed into the top of the side panels;
wherein the side panels are configured to define toggle receptacles at a point proximate to a lower portion of the base panel when installed and at a point proximate to a lower portion of the top panel when installed, and wherein the base panel is configured to define at least one hook receptacle on a lower portion of the base panel, and the top panel is configured to define at least one hook receptacle on a lower portion of the top panel; and
wherein when hook and toggle fasteners are configured such that when the base panel is placed over the tops of the rigid support plates and the top panel is placed over the tops of the side panels and back panel, the hook and toggle fasteners are capable of alignment so as to lock the base panel to the side panels and to lock the top panel to the side panels.

15. The method of claim 14, further comprising providing one or more shelves, and wherein the kit is configured so that the one or more shelves may be attached to an inside portion of the two side panels.

16. The method of claim 14, further comprising providing one or more door panels that, upon assembly, are configured to be pivotally attached to the front portion of the side panels.

17. The method of claim 14, wherein the fastener comprises a spring loaded toggle latch such that an assembled unit is resilient upon loading and unloading.

18. The method of claim 14, wherein the back panel defines at least one position member receptacle within the contiguous top surface.
